(19) United States
(12) Patent Application Publication
(10) Pub. No.: US 2007/0195669 A1
(43) Pub. Date: Aug. 23, 2007

(54) Disk control circuit

(76) Inventors: Kiyoaki Hoshino, Ukyo-Ku (JP); Shiro Eshita, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/707,444

(22) Filed: Feb. 16, 2007

(30) Foreign Application Priority Data
Feb. 20, 2006 (JP) JP2006-041986

(51) Int. Cl. G11B 7/00

(52) U.S. Cl. 369/53.2

(57) ABSTRACT

A disk control circuit at least reproduces a plurality of disk media having different formats. A rotation control circuit control rotation of a disk medium to be determined. A pattern detection circuit detects a data pattern, which is unique to the disk medium, among pieces of information recorded on the disk medium. A disk determination circuit counts the number of detected unique data patterns for one rotation, based on outputs of the pattern detection circuit and the rotation control circuit, and then determines the format of the disk medium based on the number of counted unique data patterns.

### BACKGROUND OF THE INVENTION

1. Field of the Invention

The present invention relates to a technology of how to determine optical disk/disc media such as DVD-RAM.

2. Description of the Related Art

In recent years, DVDs (Digital Versatile Disc) which are optical disks are finding the wider use as mass-storage media. Such DVD media are now and will be widely used for the recording of data in personal computers, the distribution of movies or audio and the like.

There are a plurality of DVD specifications such as DVD-ROM, DVD±RW, DVD±R and DVD-RAM. And the disk format for each of such kinds of DVDs differ according to each of such specifications. Under this circumstance, a disk apparatus has been developed which is a so-called combo drive capable of reproducing or recording media data on DVDs whose formats differ from one another.

To reproduce media data of such a plurality of disks having different formats or record information, a reproduction method and a recording method suitable for the format of a disk in question need to be employed. Thus the type of disk medium needs to be determined prior to the reproduction or recording. Several technologies have been proposed to determine such a plurality of disk media (See References (1) to (4) in the following Related Art List, for instance).

### Related Art List

(1) Japanese Patent Application Laid-Open No. Hei08-263930.
(2) Japanese Patent Application Laid-Open No. Hei08-307419.
(3) Japanese Patent Application Laid-Open No. Hei09-7288.
(4) Japanese Patent Application Laid-Open No. Hei09-198780.
(5) Japanese Patent Application Laid-Open No. Hei09-282784.

### SUMMARY OF THE INVENTION

The present invention has been made in view of the foregoing problems of determining disk media as in the aforementioned references, and a general purpose thereof is to determine more accurately predetermined disk media.

One embodiment of the present invention relates to a method for determining a type of a disk medium. This determining method includes: rotating the disk medium to be determined; detecting a unique data pattern recorded on the disk medium; counting the number of unique data patterns; and determining the disk medium based on the number of counted data patterns.

According to this embodiment, a disk medium is rotated for a predetermined angle or for a predetermined duration of time, a pattern containing a predetermined bit sequence is detected and then the number of patterns detected is counted. As a result, the format of the disk medium can be determined with accuracy.

The unique data pattern may be a plurality of pieces of header information recorded for each rotation. In such a case, the occurrence of false detections due to noise can be reduced as compared to a case where the presence or absence of header information is detected or the number of pieces of header information is counted. Thus, the type of disk medium can be determined with accuracy.

The unique data pattern may be VFO (Variable Frequency Oscillator) information contained in the header information.

A format of the disk medium to be determined may be DVD-RAM. Identifying such unique data as VFO information allows optimum determination of DVD-RAM and other DVD media.

Another embodiment of the present invention relates to a disk control circuit for at least reproducing a plurality of disk media having different formats. This disk control circuit comprises: a rotation control circuit which controls rotation of a disk medium to be determined; a pattern detection circuit which detects a data pattern, which is unique to the disk medium, among pieces of information recorded on the disk medium; and a disk determination circuit which counts the number of detected unique data patterns, based on outputs of the pattern detection circuit and the rotation control circuit, and which determines a format of the disk medium based on the number of counted unique data patterns.

According to this embodiment, a pattern containing a predetermined bit sequence is detected and then the number of patterns detected is counted, so that the format of a disk medium can be determined with accuracy.

The pattern detection circuit may detect, as the unique data pattern, a pattern contained in a plurality of pieces of header information recorded for one disk rotation of the disk medium. The pattern detection circuit may detect, as the unique data pattern, VFO (Variable Frequency Oscillator) information contained in the header information.

Still another embodiment of the present invention relates to a disk apparatus. This apparatus comprises: a disk control circuit; and a motor which rotates a disk medium to be determined, wherein the disk control circuit controls rotation of the motor, detects a pattern recoded on the disk medium and determines format thereof.

It is to be noted that any arbitrary combination or rearrangement of the above-described structural components and so forth are effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a block diagram showing a structure of a disk apparatus according to an embodiment of the present invention;

FIGS. 2A and 2B each illustrates a format of DVD-RAM;

FIG. 3 is a flowchart showing a method for determining a disk type by a disk control circuit shown in FIG. 1; and

FIG. 4 illustrates the presence or absence of header and VFO data for each of different types of disk media.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

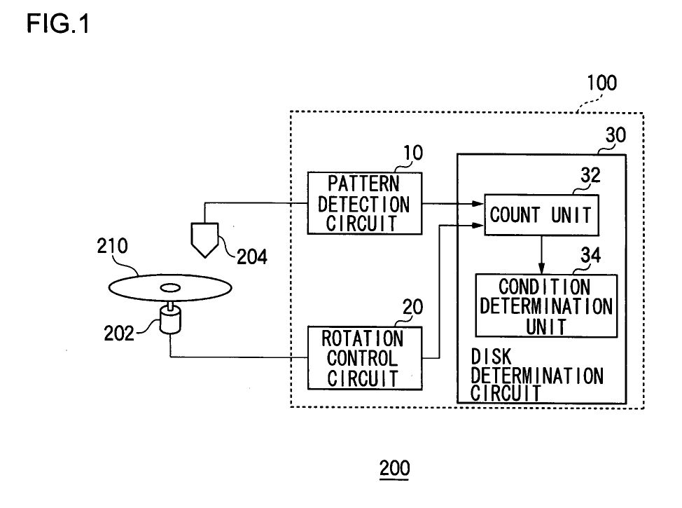

FIG. 1 is a block diagram showing a structure of a disk apparatus 200 according to an embodiment of the present invention. The disk apparatus 200 shown in FIG. 1, which is incorporated into an electronic apparatus such as a personal computer and a DVD recorder, is used to reproduce images, audio data and other digital data or record information.

In the present embodiment, the disk apparatus 200 is capable of at least reproducing a plurality of types of disk media whose formats differ. In some instances, the disk apparatus 200 may be a so-called combo drive capable of recording information on those disk media.

In the present embodiment, assume that the disk apparatus 200 is capable of reproducing disk media at least in the DVD-RAM format and also the disk media in other formats such as DVD-ROM and DVD-R.

The disk apparatus 200 is comprised of a motor 202, a pickup 204, and a disk control circuit 100. The motor 202 is a rotation mechanism, which rotates a disk medium 210 inserted in the disk apparatus 200, and is a spindle motor and the like, for example.

The pickup 204 irradiates the disk medium 210 with laser and detects the light reflected from the disk medium 210. The pickup 204 converts the detected light into weak electric signals. The electric signal outputted from the pickup 204 is amplified by an unshown amplifier.

The disk control circuit 100 is a circuit by which to control the rotation frequency of the motor 202 and the position of the pickup 204 in accordance with a disk medium 210 from or to which data are to be read out or written. This circuit is also used to set the intensity of laser irradiated to the disk medium 210. Accordingly, when the disk medium 210 is inserted to a disk apparatus, the disk control circuit 100 needs to first determine the format of the disk medium 210.

The disk control circuit 100 shown in FIG. 1 is comprised of blocks necessary for determining the formats of disk media. A disk control circuit 100 according to the present embodiment is comprised of a pattern detection circuit 10, a rotation control circuit 20, and a disk determination circuit 30, all of which are normally integrated onto a single semiconductor substrate as a function IC. Note that only blocks required for determining the format is shown in FIG. 1 and other blocks are omitted.

In terms of hardware, each element which is shown in FIG. 1 and described as a function block performing various processing scan be realized by a circuit element such as a transistor. In terms of software, it can be realized by programs running on a CPU or the like. Hence, it is understood by those skilled in the art that these function blocks can be realized in a variety of forms such as by hardware only, software only or the combination thereof and should not be considered as limited to any particular one.

The rotation control circuit 20 controls the rotation frequency of the motor 202 according to the format of a disk medium to be determined. A circuit (not shown), which is a so-called a motor driver, for driving a motor 202 is connected with the rotation control circuit 20. And this circuit specifies the rotation frequency of a motor to the motor driver. A signal corresponding to the rotation frequency of the motor 202 is inputted to the rotation control circuit 20 from the unshown motor driver or a Hall element, so that the rotation frequency of the motor 202 can be determined.

The pattern detection circuit 10 detects data having a pattern (bit sequence) specific to the disk medium in question among pieces of information recorded on the disk medium 210. Hereinafter, this data will be referred to as “unique data” or “intrinsic data”. A description will be given hereunder of a case, for example, where a disk medium of the DVD-RAM format is to be determined.

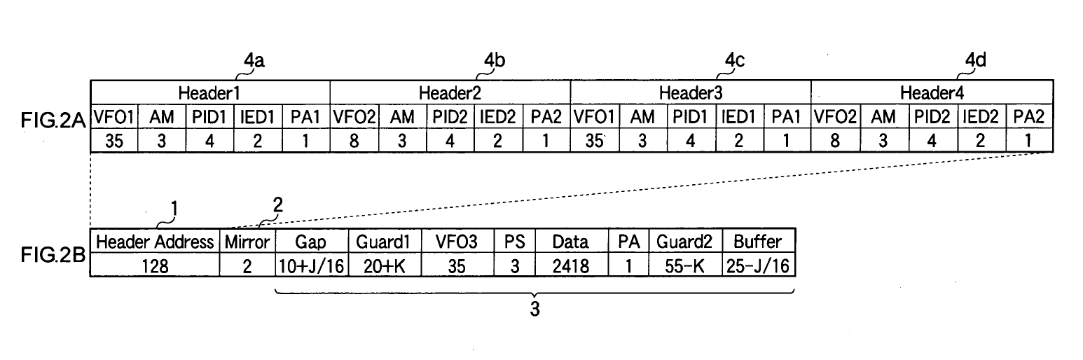

FIGS. 2A and 2B each illustrates a format of DVD-RAM. The numbers in FIGS. 2A and 2B represent the numbers of bytes. FIG. 2B illustrates formats of sectors in which a track (one rotation) of a DVD-RAM disk medium is divided. 128-byte Header Address Data 1 is written to the header of a sector. Mirror Data 2 is written following the Header Address Data 1. In an unrecorded disk medium, nothing is recorded in Gap to Buffer Data 3 and therefore the Data 3 is blank. It is to be noted here that the term “one rotation” or “one disk rotation” in this patent specification means one full turn of a disk medium, namely, a 360-degree disk rotation. Hereinafter, the same applies also to “rotation” in “per rotation” and the like.

FIG. 2A illustrates, in detail, data contained in the Header Address Data 1. Four Header Data 4a to 4d are contained in the Header Address Data 1. The Header Data 4a to 4d each contains VFO (Variable Frequency Oscillator) data to control a PLL (Phase-Locked Loop), AM (Address Mark) data, PID (Physical ID) data to which a sector number is assigned, IED (ID Error Detection) data holding ID error detection information, and PA (Postamble) data to set an initial state of data modulation. These pieces of header information are formed as pre-pits at the time of manufacturing a disk substrate.

Among data contained in the header data 4, VFO data and AM data are intrinsic to the medium and have a pattern common to all of the headers. More specifically, VFO data and AM data are structured by the following patterns.

VFO={4T, 4T, 4T, . . . }, and

AM={4T, 4T, 14T, 4T, 4T, 14T, 4T},

where 1T is called a channel bit and has a length corresponding to 1 clock, and 1 byte is equal to 16T.

PA data are also unique data inside the header of a DVD-RAM, and are structured by the following patterns.

PA1={6T, 6T, 4T} or {4T, 4T, 4T, 4T}

PA2={1T, 4T, 3T, 4T, 4T} or {1T, 5T, 6T, 4T}

The disk control circuit 100 according to the present embodiment detects the pattern of VFO data as the data intrinsic to a DVD-RAM disk medium. Based on the number of VFO data detected, the disk control circuit 100 determines if the disk medium to be determined is a DVD-RAM or not.

Refer back to FIG. 1. When a disk medium is inserted, the rotation control circuit 20 rotates the motor 202. The pickup 204 reads out the recorded information while the disk medium 210 is being rotated. The pattern detection circuit 10 detects a VFO pattern from signals read out by the pickup 204. A count unit 32 in the disk determination circuit 30 counts the number of pieces of VFO data detected by the pattern detection circuit 10. The count unit 32 receives rotation information on the motor 202 from the rotation control circuit 20 and based on this information it derives the number of unique data (VFO data) per rotation of the disk medium 210. The number of unique data per rotation may be derived in a manner that the disk medium is rotated for several rotations to detect the VFO data and then an average value thereof is calculated.

In the case when the unique data (VFO data) is to be detected by the pattern detection circuit 10, it is possible to detect the sequence of 4T's as described above. However, either a rising edge (positive edge) or a falling edge (negative edge) for every 8T or the both edges may be detected. Of the input data read out from the disk, the VFO data, for example, swings in a period of 8T with a certain reference value as the center. Then the range higher than a slice level is detected as a high level and the range lower than the slice level is detected as a low level. As a result, if the slice level is set exactly to the center value of an input signal, a periodic signal having 4T in high level and 4T in low level will appear. Nevertheless, there may arise a case where the slice level and the center value do not agree if the tracking is unstable and slice level is not fixed. In such a case, the patterns such as 3T and 5T instead of 4T and 4T may possibly be detected. If this occurs, the VFO data can be accurately detected by detecting either a positive edge or a negative edge for every 8T or the both edges.

For example, the pattern detection circuit 10 may read out information recorded in the innermost track of a disk medium 210 to be determined and then detect unique data recorded in the innermost track. For example, twenty five headers are recorded in the inner periphery of a DVD-RAM per rotation (per track). Since one piece of VFO data is contained for every header information, 25×4=100 unique data will be detected for one rotation.

The count unit 32 outputs the number of unique data per rotation to a condition determination unit 34. Based on the number of unique data outputted from the count unit 32, the condition determination unit 34 determines the format of the disk medium 210. For example, if the number of unique data in a disk medium data 210 is in the range of 90 to 110, the format of the disk medium 210 will be determined to be DVD-RAM.

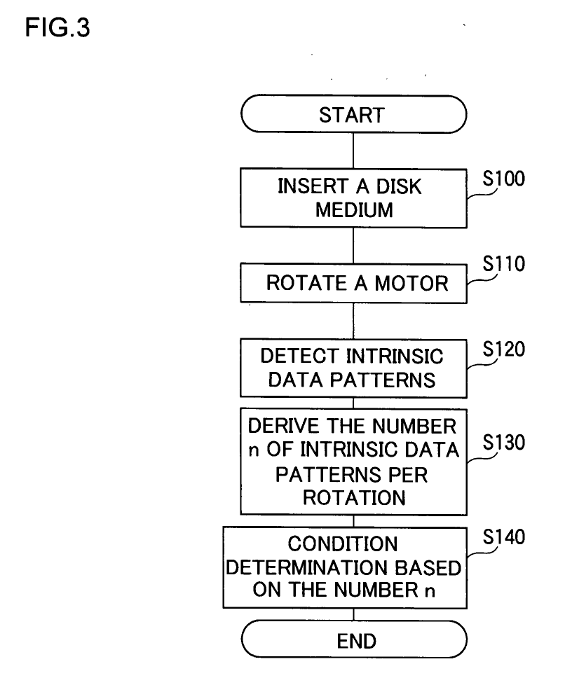

FIG. 3 is a flow chart showing a method for determining a disk type by the disk control circuit 100 according to the present embodiment.

As a disk medium is inserted (S100), a motor starts rotating (S110). The pattern detection circuit 10 detects VFO data as the intrinsic data (S120). Subsequently, the count unit 32 derives the number n of intrinsic data per disk rotation (S130). Then the format of disk medium 210 is determined based on the number n (S140).

In this manner, by employing the disk control circuit 100 and the disk apparatus according to the present embodiment, data having patterns intrinsic to a disk media in question is detected and the number of them per disk rotation is derived, thereby determining the format of the disk medium. As a result, the accuracy in determination can be enhanced as compared to a case where the format of a disk medium is determined simply based on whether there is a header or not.

The above embodiments are merely exemplary and it is understood by those skilled in the art that various modifications to the combination of each component and process thereof are possible and such modifications are also within the scope of the present invention.

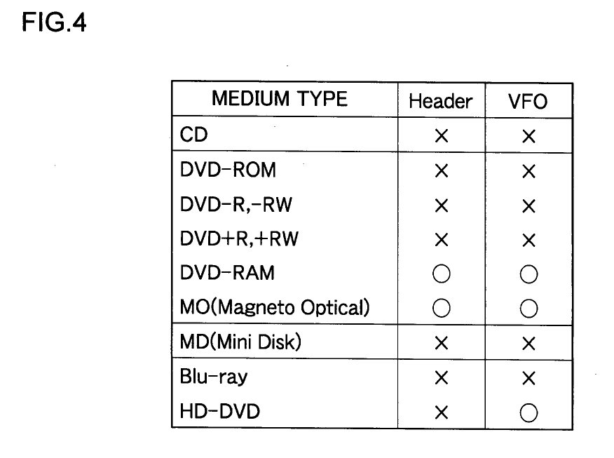

Though in the present embodiments a description has been given of a case of determining the DVD-RAM, the present invention is not limited thereto. FIG. 4 illustrates the presence or absence of header and VFO data for each of different types of disk media. Referring to FIG. 4, if the VFO data are to be detected, the disk types of MO (Magneto Optical) and HD-DVD, a next-generation DVD specification, in addition to the DVD-RAM can be determined. Note that the number of VFO data for one disk rotation decreases in the order of DVD-RAM>HD-DVD>other disk media.

Further, if the disk medium is determined using VFO data, the disk type of MO medium will also be able to be determined. MO media are currently available in a capacity of 128 MB, 230 MB, 540 MB, 640 MB, 1.3 GB, 2.3 GB and the like. Here, the number of sectors per track is predetermined in accordance with the type of disk medium. Thus the type of MO data can be determined by detecting the number of VFO data.

In the present embodiments, a description has been given of a case where VFO data are detected as unique data. However, the present invention is not limited thereto and, for example, AM data or PA data may be detected as unique data. In order to enhance the accuracy, those different data may be combined to determine the format of the disk media.

In the present embodiments, a description has been given of a case where the number of unique data is counted per rotation. However this should not be considered as limiting and the number of unique data per predetermined angle of, for example, 180 degrees (half-turn) may be counted. As another example, a disk may be rotated for a predetermined duration of time and the unique data detected for that duration may be counted.

While the preferred embodiments of the present invention have been described using specific terms, such description is for illustrative purposes only, and it is to be understood that changes and variations may be further made without departing from the spirit or scope of the appended claims.

What is claimed is:

1. A method for determining a type of a disk medium, wherein the disk medium to be determined is rotated, the method including:
rotating the disk medium to be determined;
detecting a unique data pattern contained in a plurality of pieces of header information recorded for one disk rotation of the disk medium;
counting the number of unique data patterns; and
determining the disk medium based on the number of counted data patterns.

2. A method for determining a type of a disk medium according to claim 1, wherein the unique data pattern is VFO (Variable Frequency Oscillator) information contained in the header information.

3. A method for determining a type of a disk medium according to claim 1, wherein a format of the disk medium to be determined is DVD-RAM.

4. A method for determining a type of a disk medium according to claim 2, wherein a format of the disk medium to be determined is DVD-RAM.

5. A disk control circuit for at least reproducing a plurality of disk media having different formats, the disk control circuit comprising:
a rotation control circuit which controls rotation of a disk medium to be determined;
a pattern detection circuit which detects a data pattern, which is unique to the disk medium, among pieces of information recorded on the disk medium; and
a disk determination circuit which counts the number of detected unique data patterns, based on outputs of said pattern detection circuit and said rotation control circuit, and which determines a format of the disk medium based on the number of counted unique data patterns.

6. A disk control circuit according to claim 5, wherein said pattern detection circuit detects, as the unique data pattern, a pattern contained in a plurality of pieces of header information recorded for one disk rotation of the disk medium.

7. A disk control circuit according to claim 6, wherein said pattern detection circuit detects, as the unique data pattern, VFO (Variable Frequency Oscillator) information contained in the header information.

8. A disk control circuit according to claim 5, wherein a format of the disk medium to be determined is DVD-RAM.

9. A disk control circuit according to claim 5, wherein said disk control circuit is integrated onto a single semiconductor substrate.

10. A disk apparatus, comprising:
a motor which rotates a disk medium to be determined; and
a disk control circuit which controls said motor, detects a pattern recorded in the disk medium and determines a format thereof,
said disk control circuit including:
a rotation control circuit which controls rotation of the disk medium to be determined;
a pattern detection circuit which detects a data pattern, which is unique to the disk medium, among pieces of information recorded on disk medium; and
a disk determination circuit which counts the number of detected unique data patterns, based on outputs of the pattern detection circuit and the rotation control circuit, and which determines the format of the disk medium based on the number of counted unique data patterns.
